(19) United States
(12) Patent Application Publication
(10) Pub. No.: US 2014/0338839 A1
(43) Pub. Date: Nov. 20, 2014

(54) LABEL AFFIXING MACHINE

(71) Applicants: FIH (Hong Kong) Limited, Kowloon (HK); Shenzhen Futaihong Precision Industry Co., Ltd., Shenzhen (CN)

(72) Inventors: BING YU, Shenzhen (CN); JIAN-PING JIN, Shenzhen (CN); YONG-FU HU, Shenzhen (CN)

(73) Assignees: FIH (Hong Kong) Limited, Kowloon (HK); SHENZHEN FUTAIHONG PRECISION INDUSTRY CO., LTD., Shenzhen (CN)

(21) Appl. No.: 14/053,685

(22) Filed: Oct. 15, 2013

(30) Foreign Application Priority Data
May 17, 2013 (CN) 2013101826226

(51) Int. Cl. B65C 9/18; B65C 9/00

(52) U.S. Cl. CPC B65C 9/18; B65C 9/0006
USPC 156/538

(57) ABSTRACT

A label affixing machine includes a feeding assembly, a transmission assembly, a pressing assembly, a stripper assembly and an unloading assembly. A strap configured for carrying labels is wound around the feeding assembly. The pressing assembly is located above the transmission assembly. The stripper assembly includes a board. The transmission assembly drives the strap to pass by the pressing assembly and the stripper assembly and move to the unloading assembly. When the label of the strap moves to a flange of the board away from the transmission assembly, the pressing assembly resists the strap located on the transmission assembly. The board moves toward the pressing assembly to loose a portion of the strap adhered to the board; the unloading assembly drives the loose portion of the strap to move to tension the loose portion of the strap to allow a part of the label to separate from the strap.

### BACKGROUND

1. Technical Field

The disclosure generally relates to label affixing machines for affixing labels on products.

2. Description of the Related Art

Labels are usually attached to various products by a label affixing machine. A typical label affixing machine has complex structures and takes up too much space.

Therefore, there is room for improvement within the art.

### BRIEF DESCRIPTION OF THE DRAWINGS

Many aspects of an exemplary label affixing machine can be better understood with reference to the following drawings. The components in the drawings are not necessarily drawn to scale, the emphasis instead being placed upon clearly illustrating the principles of the exemplary label affixing machine. Moreover, in the drawings, like reference numerals designate corresponding parts throughout the several views. Wherever possible, the same reference numbers are used throughout the drawings to refer to the same or like elements of an embodiment.

FIG. 1 is an assembled view of a label affixing machine, according to an exemplary embodiment.

FIG. 2 is a side view of the label affixing machine shown in FIG. 1.

### DETAILED DESCRIPTION

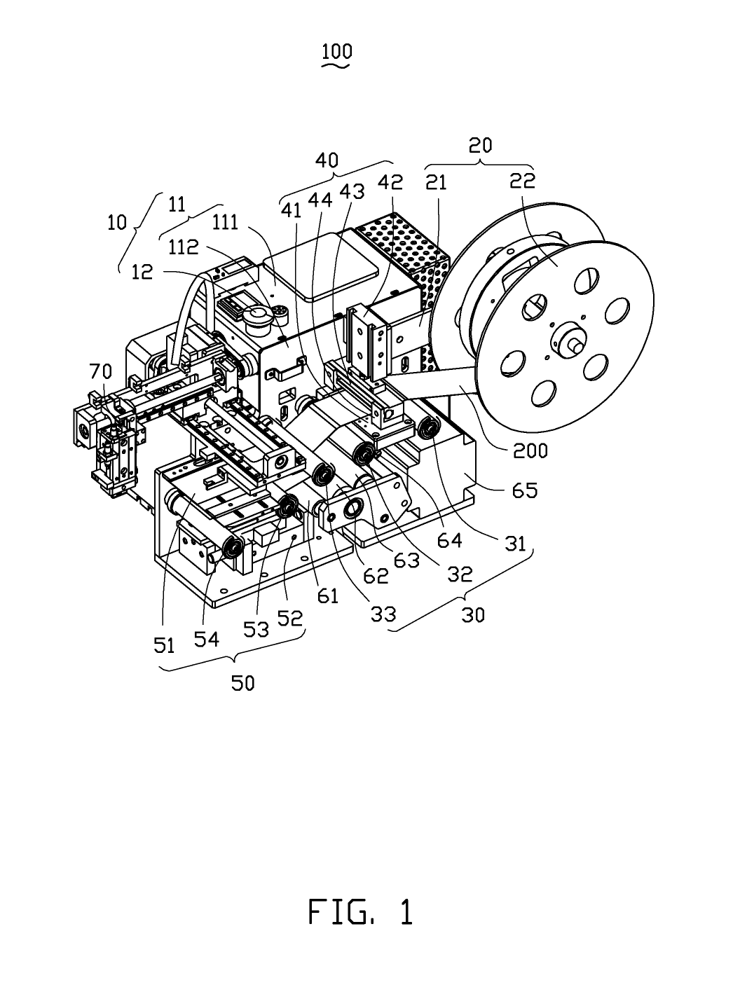

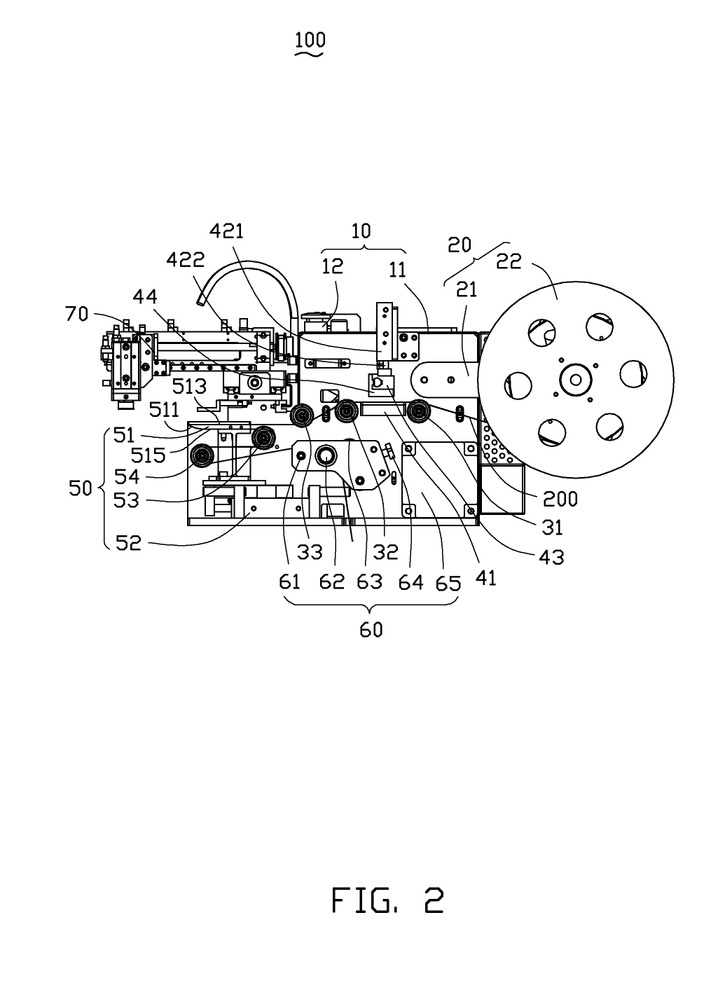

FIG. 1 and FIG. 2 show a label affixing machine 100 for affixing labels on products. The label affixing machine 100 includes an operating element 10, a feeding assembly 20, a transmission assembly 30, a pressing assembly 40, a stripper assembly 50, an unloading assembly 60, and a robot arm 70. A strap 200 with labels (not shown) is wound around the feeding assembly 20. The transmission assembly 30 is located at a side of the feeding assembly 20 and drives the strap 200 to pass by the pressing assembly 40 and the stripper assembly 50 and move to the unloading assembly 60. The pressing assembly 40 is used for resisting and releasing the strap 200 located on the transmission assembly 30. The stripper assembly 50 is located at one side of the transmission assembly 30 and is used for stripping the labels from the strap 200.

The operating element 10 includes a receiving box 11 and a button 12. The receiving box 11 includes a first wall 111 and a second wall 112 perpendicularly connected to the first wall 111. A plurality of electrically controlled components for controlling the label affixing machine 100 are received in the receiving box 11. The button 12 is located on the first wall 111.

The feeding assembly 20 includes a fixing plate 21 and a reel 22. The fixing plate 21 is fixed on the second wall 112. The reel 22 is rotatably connected to the fixing plate 21. The strap 200 with the labels is wound around the reel 22.

The transmission assembly 30 includes a first roller 31, a second roller 32, and a third roller 33. The first roller 31, the second roller 32, and the third roller 33 are arranged parallel to each other and are perpendicularly located on the second wall 112. The first roller 31, the second roller 32 and the third roller 33 are spaced from each other.

The pressing assembly 40 includes a support plate 41, a first cylinder 42, a connecting block 43, and two pressing blocks 44. The support plate 41 is located between the first roller 31 and the second roller 32, and is perpendicularly located on the second wall 112. The first cylinder 42 located above the support plate 41 includes a receiving cavity 421 and a telescopic rod 422. The receiving cavity 421 is perpendicularly connected to the second wall 112. An end of the telescopic rod 422 is received in the receiving cavity 421, and the other end of the telescopic rod 422 is connected to the connecting block 43. The two pressing blocks 44 are slidably connected to the connecting block 43.

The stripper assembly 50 includes a board 51, a second cylinder 52, a first rolling wheel 53, and a second rolling wheel 54. The board 51 is located adjacent to the third roller 33 and is fixed on the second wall 112. The board 51 is substantially a rectangular plate and includes a slope 511 formed at an end of the board 51, a first surface 513 and a second surface 515 parallel to the first surface 513. The slope 511 connects the second surface 515 to the first surface 513. The second cylinder 52 is located under the board 51 and is connected to the board 51. The second cylinder 52 drives the board 51 to move. The first rolling wheel 53 and the second rolling wheel 54 are spaced from each other and are perpendicularly located on the second wall 112. The first rolling wheel 53 and the second rolling wheel 54 are located between the board 51 and the second cylinder 52.

The unloading assembly 60 is located under the transmission assembly 30 and includes a first rolling shaft 61 for guiding the strap 200, a second rolling shaft 62, a third rolling shaft 63, an adjusting element 64 and a motor 65. The first rolling shaft 61, the second rolling shaft 62, and the third rolling shaft 63 are perpendicularly located on the second wall 112. The second rolling shaft 62 is located between the first rolling shaft 61 and the third rolling shaft 63. The adjusting element 64 movably resists the third rolling shaft 63. The motor 65 is electronically connected to the second rolling shaft 62 and drives the second rolling shaft 62 to rotate.

The robot arm 70 is mounted on the receiving box 11 and can move the label to the product.

The working process of the label affixing machine 100 is illustrated as follows:

The strap 200 is wound around the reel 22, and a free end of the strap 200 passes by the first roller 31, the support plate 41, the second roller 32 and the third roller 33 successively and moves to the first surface 513 of the board 51. Portions of the strap 200 adhered to the first roller 31, the support plate 41, the second roller 32 are located at a same side of the first roller 31, the support plate 41 and the second roller 32. Portions of the strap 200 adhered to the second roller 32 and the third roller 33 are substantially S shaped. The free end of the strap 200 passes by the first surface 513, the slope 511, and the second surface 515 successively and moves to the first rolling wheel 53. The free end of the strap 200 passes by the first rolling wheel 53 and the second rolling wheel 54, and portions of the strap 200 adhered to the first rolling wheel 53 and the second rolling wheel 54 are substantially S shaped.

The free end of the strap 200 passes by the first rolling shaft 61 and the second rolling shaft 62 after bypassing the second rolling wheel 54, and portions of the strap 200 adhered to the first rolling shaft 61 and the second rolling shaft 62 is located at a same side of the first rolling shaft 61 and the second rolling shaft 62. The free end of the strap 200 passes by the second rolling shaft 62 and is clamped between the second rolling shaft 62 and the third rolling shaft 63. A distance between the second rolling shaft 62 and the third rolling shaft 63 can be adjusted by rotating the adjusting element 64. The above described strap 200 from the first roller 31 to the third rolling shaft 63 is without the labels, and the rest of the strap 200 wound around the reel 22 is with the labels.

The button 12 is pressed to start the label affixing machine 100. The first roller 31, the second roller 32, the third roller 33, the first rolling wheel 53, the second rolling wheel 54, and the second rolling shaft 62 rotate and drive the strap 200 wound around the reel 22 to move. When the label of the strap 200 is moved to a joint between the first surface 513 and the slope 511, then the first cylinder 42 moves toward the support plate 41 until the two pressing blocks 44 resists the strap 200 located on the support plate 41.

The first roller 31, the second roller 32 and the third roller 33 stop rotating. The second cylinder 52 drives the board 51 to move toward the support plate 41, and portion of the strap 200 adhered to the board 51 is loose due to lack of support of the board 51. The first rolling wheel 53, the second rolling wheel 54, and the second rolling shaft 62 rotate and drive the loose portion of the strap 200 to move to tension the loose portion of the strap 200, a friction force between the label and the strap 200 is smaller than a driving force of the first rolling wheel 53, thus part of the label separates from the strap 200. The robot arm 70 picks the label and moves the label to the product.

The first cylinder 42 moves away from the support plate 41, and the two pressing blocks 44 moves away from the strap 200 located on the support plate 41. The first roller 31, the second roller 32, the third roller 33, the first rolling wheel 53, the second rolling wheel 54, and the second rolling shaft 62 rotate and drive the strap 200 wound around the reel 22 to move. Meanwhile, the second rolling shaft 62 and the third rolling shaft 63 rotate to export the strap 200 without the labels. When the label of the strap 200 is moved to a joint between the first surface 513 and the slope 511, then the first cylinder 42 moves toward the support plate 41 until the two pressing blocks 44 resists the strap 200 located on the support plate 41, and the above operation described in paragraph [0019] repeats.

The label affixing machine 100 with simple structure is small in size and is convenient to operate.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in the matters of shape, size, and arrangement of parts within the principles of exemplary disclosure to the full extent indicated by the broad general meaning of the terms in which the appended claims are expressed.

What is claimed is:

1. A label affixing machine for affixing labels on products, the label affixing machine comprising:
a feeding assembly;
a strap configured for carrying the labels being wound around the feeding assembly;
a transmission assembly driving the strap to move;
a pressing assembly located above the transmission assembly;
a stripper assembly comprising a board located adjacent to the transmission assembly; and
an unloading assembly;
wherein the transmission assembly drives the strap to pass by the pressing assembly and the stripper assembly and move to the unloading assembly; when the label of the strap moves to a flange of the board away from the transmission assembly, the pressing assembly resists the strap located on the transmission assembly; the board moves toward the pressing assembly to loose a portion of the strap adhered to the board, the unloading assembly drives the loose portion of the strap to move to tension the loose portion of the strap to allow a part of the label to separate from the strap.

2. The label affixing machine as claimed in claim 1, wherein the feeding assembly comprises a reel, and the strap is wound around the reel.

3. The label affixing machine as claimed in claim 1, wherein the transmission assembly comprises a first roller, a second roller and a third roller; the first roller, the second roller and the third roller are parallel and spaced to each other.

4. The label affixing machine as claimed in claim 3, wherein the pressing assembly comprises a support plate, a first cylinder, and a connecting block; the support plate is located between the first roller and the second roller, the first cylinder is located above the support plate and is connected to the connecting block.

5. The label affixing machine as claimed in claim 4, wherein the pressing assembly further comprises two pressing blocks slidably connected to the connecting block.

6. The label affixing machine as claimed in claim 4, wherein the stripper assembly further comprises a second cylinder, the board is located adjacent to the third roller, the board comprises a slope formed at an end of the board; the second cylinder is connected to the board and drives the board to move.

7. The label affixing machine as claimed in claim 6, wherein the unloading assembly comprises a first rolling shaft located adjacent to the stripper assembly, a second rolling shaft, a third rolling shaft, and a motor, the second rolling shaft is located between the first rolling shaft and the third rolling shaft, the motor is electronically connected to the second rolling shaft and drives the second rolling shaft to rotate.

8. The label affixing machine as claimed in claim 7, wherein the unloading assembly further comprises an adjusting element, the adjusting element resists the third rolling shaft movably, and the adjusting element rotates to adjust a distance between the second rolling shaft and the third rolling shaft.

9. The label affixing machine as claimed in claim 1, further comprising an operating element, wherein the operating element comprises a receiving box and a button, the receiving box comprises a first wall and a second wall perpendicularly connected to the first wall, the button is located on the first wall and the feeding assembly, the transmission assembly, the pressing assembly, the stripper assembly and the unloading assembly are located on the second wall.

10. The label affixing machine as claimed in claim 1, further comprising a robot arm for picking the label and moving the label to the product.

11. A label affixing machine comprising:
an operating element for starting the label affixing machine;
a feeding assembly;
a strap configured for carrying labels being wound around the feeding assembly;
a transmission assembly for driving the strap to move;
a pressing assembly located above the transmission assembly;
a stripper assembly comprising a board; and
an unloading assembly;
wherein the transmission assembly drives the strap to pass by the pressing assembly and the stripper assembly and move to the unloading assembly; when the label of the strap moves to a flange of the board away from the transmission assembly, the pressing assembly resists the strap located on the transmission assembly; the board moves toward the pressing assembly to loose a portion of the strap adhered to the board, the unloading assembly drives the loose portion of the strap to move to tension the loose portion of the strap to allow a part of the label to separate from the strap.

12. The label affixing machine as claimed in claim 11, wherein the feeding assembly comprises a reel, the strap with the labels is wound around the reel.

13. The label affixing machine as claimed in claim 11, wherein the transmission assembly comprises a first roller, a second roller and a third roller; the first roller, the second roller and the third roller are parallel and spaced to each other.

14. The label affixing machine as claimed in claim 13, wherein the pressing assembly comprises a support plate, a first cylinder, and a connecting block; the support plate is located between the first roller and the second roller, the first cylinder is located above the support plate and is connected to the connecting block.

15. The label affixing machine as claimed in claim 14, wherein the pressing assembly further comprises two pressing blocks slidably connected to the connecting block.

16. The label affixing machine as claimed in claim 14, wherein the stripper assembly further comprises a second cylinder, the board is located adjacent to the third roller, the board comprises a slope formed at an end of the board; the second cylinder is connected to the board and drives the board to move.

17. The label affixing machine as claimed in claim 16, wherein the unloading assembly comprises a first rolling shaft located adjacent to the stripper assembly, a second rolling shaft, a third rolling shaft, and a motor, the second rolling shaft is located between the first rolling shaft and the third rolling shaft, the motor is electronically connected to the second rolling shaft and drives the second rolling shaft to rotate.

18. The label affixing machine as claimed in claim 17, wherein the unloading assembly further comprises an adjusting element, the adjusting element resists the third rolling shaft movably, and the adjusting element rotates to adjust a distance between the second rolling shaft and the third rolling shaft.

19. The label affixing machine as claimed in claim 11, wherein the operating element comprises a receiving box and a button, the receiving box comprises a first wall and a second wall perpendicularly connected to the first wall, the button is located on the first wall and the feeding assembly, the transmission assembly, the pressing assembly, the stripper assembly and the unloading assembly are located on the second wall.

20. The label affixing machine as claimed in claim 11, further comprising a robot arm for picking the label and moving the label to the product.
